(19) United States
(12) Patent Application Publication
(10) Pub. No.: US 2003/0037302 A1
(43) Pub. Date: Feb. 20, 2003

(54) Systems and methods for automatically converting document file formats

(76) Inventor: Aliaksei Dzienis, Providence, RI (US)

Correspondence Address: Robert J. Depke, Holland & Knight LLP, Suite 800, 55 West Monroe Street, Chicago, IL, 60603-5144, US

(21) Appl. No.: 10/177,953

(22) Filed: Jun. 21, 2002

Related U.S. Application Data
(60) Provisional application No. 60/300,662, filed on Jun. 24, 2001.

(51) Int. Cl. G06F 15/00

(52) U.S. Cl. 715/523

(57) ABSTRACT

Systems and methods provide parallel processing for simultaneously converting a plurality of files into various file formats into a common file format. Electronic storage media containing multiple files in various file formats is made accessible to a plurality of personal computers connected through a network. The plurality of computers simultaneously converts the files into a common format for storage.

This application is a continuation-in-part of provisional patent application serial No. 60/300,662 filed Jun. 24, 2001 which is incorporated herein by 60/300,662 by reference. Applicants claim priority to application serial No. 60/300,662 filed Jun. 24, 2001.

### BACKGROUND OF THE INVENTION

1. Field of The Invention

The present invention relates generally to the field of computer automated document and file management systems. More specifically, the present invention is directed to systems and methods for automatically converting a plurality of document files in various native formats to a single common format. The present invention is particularly applicable to the field of document management systems.

2. Description of the Related Art

There are currently a variety of systems and techniques for converting electronic source documents such as, for example, text files, spreadsheets, and processing documents, database files, electronic mail messages and groupware documents as well as other files from their original file formats to other file formats such as, for example, the TIFF format (tagged image file format). There are also currently available systems and methods for managing both the original file and its file transformation in high volume, high speed situations such as in investigations and the like.

In the course of commercial litigation, government reviews or due diligence efforts, enormous quantities of electronic documents and electronic mail message information must be handled and reviewed for production. In light of the wide range of file formats and the number of native applications that are required for viewing the various formats in which the information resides, it is awkward and cumbersome to review these materials in their native format. It has been recognized that it is more useful to have a single common format in which all of the information resides. Furthermore, it is desirable to have a software application that renders the document as a single-page image (TIFF images, for example, or other useful transformations) so that they can be easily viewed and printed in a consistent manner similar to paper documents which are part of the conventional production process.

Occasionally, it remains useful to have output from such applications printed to paper but software applications can provide the opportunity to take control over the material when the material still is in electronic form. Prior solutions to creating a single format for the various documents utilized a single-threaded application which processed files sequentially through opening the files in place and producing TIFF images to the same network storage location where the files were found. This required a significant amount of manual intervention during the transformation processing. These types of prior approaches to providing these types of solutions are extremely inefficient in that the prior solution required an individual to manually open each individual file in a specific file format and thereafter make the appropriate transformation to the desired common format.

It has now been recognized that further automation of the overall process will increase efficiency and provide a significantly improved and more economical solution to providing this type of service. Accordingly, one object of the present invention is to improve the speed of these operations. It is a further object of the present invention to reduce and eliminate errors that arise during the transformation operation. Yet another object and advantage of the present invention is to provide a quicker more economic solution while maintaining data integrity and flexibility of the overall processing.

### SUMMARY OF THE INVENTION

In accordance with an exemplary embodiment of the present invention, new and improved systems and methods combine an application programming interface (API such as, for example, Microsoft's Office Automation) along with a print driver that may be utilized together in a multi-level automated queuing environment. The system is capable of dealing with each application file in its native environment or an equivalent thereof such as the closest available approximation. In accordance with the preferred exemplary embodiment, the system creates an instance of the native application in which a file resides using the API and manipulates that application instance to modify each file.

In the preferred exemplary embodiment, multiple individual processing elements such as, for example, a plurality of personal computing devices interconnected through a network provide a multi-threaded system with much more robust execution and error handling routines than solutions utilizing individual machines providing single threaded solutions. The systems and methods of the present invention provide a much more elaborate range of functionality than prior file management systems and also provide a simplified interface for greater effectiveness with respect to data formatting conversion operations.

The systems and methods provide the pre-processing of application files that are to be converted and for ensuring that correct results are achieved. Additionally, the systems and methods of the preferred exemplary embodiments provide local processing, improved error and exception handling all while utilizing multiple threads. An extremely large number of electronic application files such as, for example, text files, Word documents, Excel spreadsheets, GIF images may be automatically converted to a manageable sequence of TIFF (tagged image file format images) at high speed and with a high degree of control and accuracy. The multi-threaded environment also provides a significant advantage in that the systems and methods of the present invention are scalable to provide sufficient processing power as needed depending upon the demands of a particular work assignment.

In accordance with an exemplary embodiment of the present invention, pre-conversion operations are utilized to condense and reduce the amount of materials, for example, the number of image pages produced per document as much as possible. In the preferred exemplary embodiments, this is achieved by examining the output of the print driver/converter prior to installing the resultant image files in their ultimate location. This provides the ability to eliminate or skip over any images that are blank or which otherwise contain no actual information.

This was a quite common typical problem in previous applications wherein spreadsheet applications would produce large numbers of blank pages when printed electronically. Accordingly, in the preferred exemplary embodiment, one of the steps preceding the actual conversion to the destination format is a step of opening each file and performing a large number of pre-processing operations such as, for example, predetermined editing and formatting operations on each file prior to sending it to the print driver for conversion into the preferred TIFF format.

One purpose of these operations is to ensure that no local information such as, the system current date and time and current disk storage location is inadvertently inserted into the converted file. This is an important pre-processing step in light of the fact that much of the information that is available in the file is exposed prior to imaging conversion. One particular advantage of this operation in the preferred exemplary embodiment is in light of the recognition that modern office applications allow some information in a document to be “hidden” in one way or another. For example, comments may not print through the normal print commands and there may be one or more hidden spreadsheet columns.

The pre-processing of the present invention provides the ability for exposing this information and ensuring that it is “un-hidden” prior to conversion. As noted above, previous approaches utilized a single personal computer workstation operating on files stored on servers attached to a local area network. These prior solutions required manual intervention for opening each individual file that resided on the server without copying the file to a local drive attached to the PC and performing the processing in local memory.

In accordance with these prior solutions, the systems would send the file to the print driver that performed the actual conversion and the print driver—executing in local memory—would rewrite the pages of the printed file back to the server location over the network. The preferred exemplary embodiments of the present invention eliminate the influence of network traffic on the overall conversion operation by first copying the source file to a temporary location on the local hard drive. The system then opens the file, performs it processing and submits the same to the printer driver converter. The print driver then writes its output back to the local drive and not to a network location.

This provides numerous advantages over previous solutions. For example, it eliminates chronic difficulty that both the office applications notably Microsoft Excel has in working with remote files over a network connection. Furthermore, it greatly speeds up the operation itself because file reads and writes to a local drive can be significantly faster than those made to a network drive. This also creates the possibility of replacing the local hard drive with a solid state device for even faster performance. Finally, this approach allows transaction-style processing. If the file cannot be processed completely for any reason from the servers perspective it is as if it were never processed at all. This thereby eliminates a whole series of operational difficulties arising from partially processed files.

Some prior applications simply crashed when they encountered a serious error such as, for example a corrupt file, an API program error, or a network-induced failure etc. The error handling mechanisms in Visual Basic are not at all robust compared other languages. Delphi and other languages usable in the present invention offer a robust and well-developed error-handling interface. In accordance with the preferred embodiments of the present invention errors can be handled without causing system crashes. The basic mechanisms for overcoming the deficiencies of the prior art is to contain or trap all errors using built-in tools of the language so that the program can assess and analyze the error.

The system then sends a message to an operator or writes a message to a log file and dispenses with the file causing the system error. The system is then able to move on without interruption thereby achieving a significant increase in productivity because program downtime is eliminated. Operators are able to know that an error has occurred, what the error is and how to deal with it. Operators are no longer required to continually scan processing machines to see if a particular process has terminated.

The preferred exemplary embodiments of the present invention provide a multi-threaded environment within which processing or file conversion occurs. A “thread” refers to a self-contained set of computer instructions that are part of a single computer program that are installed and execute in the process memory simultaneously with apparent program. An ordinary, single-function computer program can be referred to as a single thread. If that computer program installed and launched several other programs (in its own “process space” that is without calling for the operating system to create an entirely new execution environment for each thread), retaining some control over communications with these other programs, these would be referred to as thread.

As described in more detail below, the preferred exemplary embodiments of the present invention utilize multiple threads to “compress” the processing operations so that operations that can execute simultaneously do so and operations that occur in sequence can be handled by multiple threads running in parallel.

In the preferred exemplary embodiments, 60 machines operate in parallel to simultaneously process and translate numerous documents in a variety of different file formats to a common file format. Those skilled in the art will appreciate that a greater number of machines or fewer may be utilized. The machines are networked and assigned a variety of file locations for transfer.

In the preferred exemplary embodiments customers will provide documents in electronic media. The media is then connected to the network of processing computers and a review is performed to determine the amount and type of data. There are essentially three automated steps in the overall process. First the data is extracted, then it is converted to a common file format and the converted data is subsequently packaged for customer utilization.

A large variety of media may be accepted for conversion such as, for example, digital tape, physical servers, CD-ROMs, or FTP. In the preferred exemplary embodiment the data is physically transferred and then connected to the network of processing machines. Those skilled in the art will appreciate that alternate embodiments may act on data sources through the Internet when the data sources are physically located at a client location.

Other features, objects and advantages of the present invention will be apparent in light of following Detailed Description of the Presently Preferred Embodiments when considered in conjunction with the accompanying drawings.

### BRIEF DESCRIPTION OF THE DRAWINGS

FIG. 1 illustrates a first exemplary embodiment of the present invention;

FIG. 2 illustrates a first exemplary embodiment of the present invention;

FIG. 3 illustrates a first exemplary embodiment of the present invention;

### DETAILED DESCRIPTION OF THE PRESENTLY OF THE PRESENTLY PREFERRED EMBODIMENTS

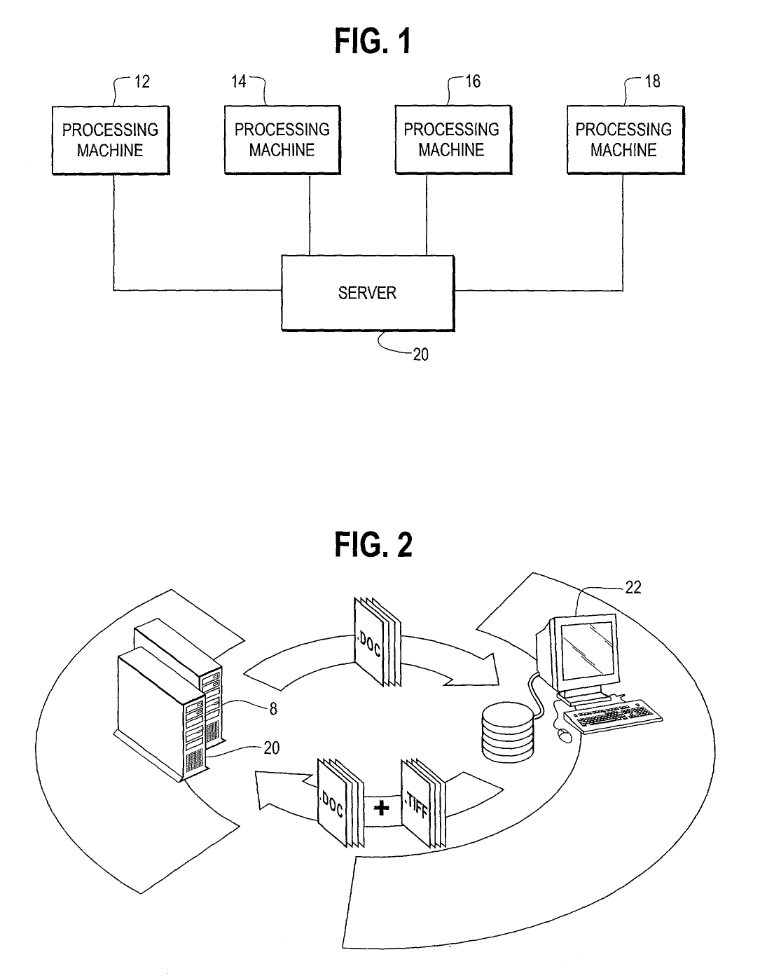

FIG. 1 illustrates a first preferred exemplary embodiment of the present invention that is shown generally at 10. In accordance with the first preferred exemplary embodiment, a plurality of processing machines 12, 14, 16, 18 are interconnected in a common network environment and perform the actual conversion processing of a plurality of files. Although only four machines have been shown for the sake of convenience, those skilled in the art will appreciate that a greater or lesser number of processing meet machines may be utilized and connected in network of processing machines.

In the preferred exemplary embodiment, 60 individual processing machines are utilized for translating files into a common format. Document files from a variety of different file formats such as, for example, Word documents, WordPerfect documents, Excel spreadsheets, etc. are translated into a common format. Advantageously, the network of processing machines may be readily scaled up or down to accommodate various processing means.

Those skilled in the art will appreciate that any existing file format may be transferred via conversion processing into a common format. In the preferred exemplary embodiments, the common format is the TIFF format. A common server 20 connected to the network may be utilized for providing interim storage for client files that are to be translated into a common file format.

As noted above, client media containing files to be translated into a common file format is physically transferred to the processing location. Those skilled in the art will appreciate that virtually any type of data storage media may be accepted for translation including tape, physical servers, CD-ROMs, or FTP. Alternatively, files may be transferred through the Internet for processing. All that is necessary is that the network of processing servers have access to the data that is to be translated into a common file format.

In the preferred exemplary embodiments, a media questionnaire is utilized in order to identify what is on the media that has been transferred for processing including all security information. The media is then restored into its original file formats in a common server that is accessible to all of the processing machines connected on the network. Each of the individual processing machines illustrated in FIG. 1 is assigned a plurality of files for conversion by the individual machine. Assignment of files for translation is made in order to balance the load on the respective processing machines.

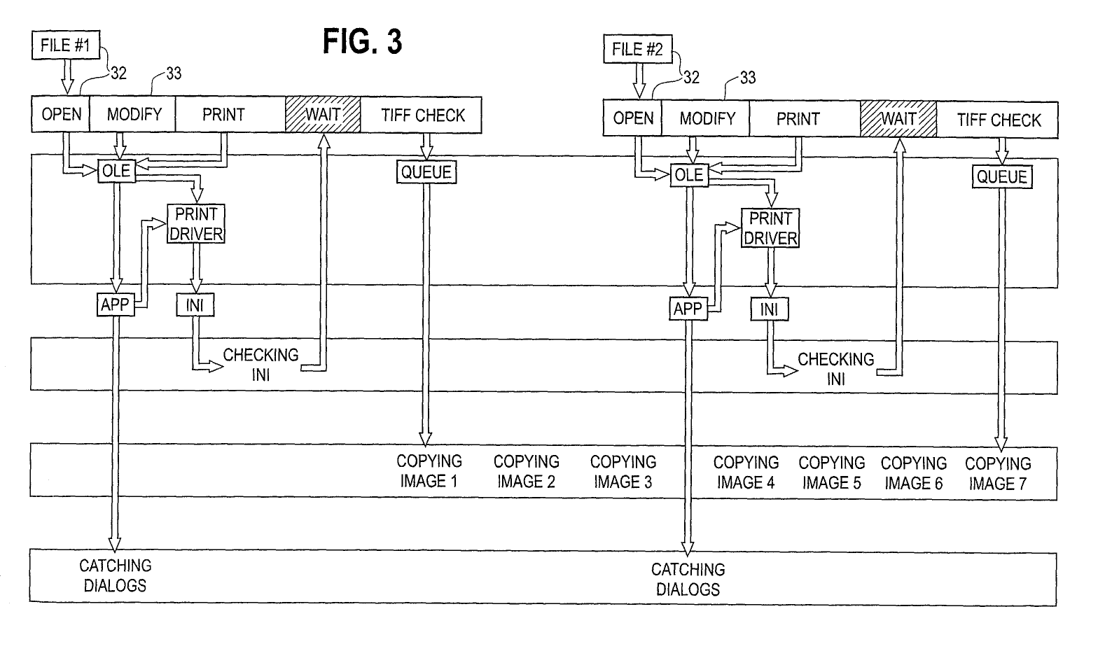

FIG. 2 illustrates the typical processing structure and operational steps performed by an individual machine in accordance with the preferred exemplary embodiments of the present invention. Source application files received from a client as noted above are stored in directories on any number storage servers in the same network as the processing CPUs 22 each with a respective local hard drive memory 24. When the application is started, the processing CPUs 22 loads into its own memory various run-time settings that are stored in the Windows Registry of the processing CPU.

The user or operator selects a target directory based on the assignment of files for the individual machine described above. The application running on the local machine 22 converts all the necessary path information to UNC format in order to avoid drive mapping inconsistencies. Before initiating operations, the program performs a pre-processing integrity check of the files. This check is performed against the control database on the server. The system then presents to the user a display highlighting any errors or problems. Once the application is processing, the files in this directory are copied one at time to the local storage device attached to the processing CPU.

Once a file has been copied to the local storage device, the program creates an instance of the appropriate application for opening and translation. The system then performs formatting checks and implements any necessary changes to properly prepare the document for printing or conversion in the desired output format. When this formatting is completed, the program automatically submits the file to the print driver for conversion to one or more TIFF images.

In the preferred exemplary embodiment, a separate thread of the program continually scans the .ini file of the print driver and sends a callback message when the print job has completed. If necessary or desired the program then uses the automation API to save the file as text, page by page, to separate OCR text files. In the preferred exemplary embodiment, the program then enters the filename into a processing queue for a separate program thread that handles moving of the file and its images back to the server. Those skilled in the art will appreciate that an alternate server may be utilized rather than the one from which the data was temporarily stored as the destination for translating files.

By performing processing in this way, the main program is available to start processing of the next file without waiting until the file and all of its images and OCR pages are copied over the network back to the server. Once all the files from a target directory or assigned directory are copied back to the storage server or destination for translated files, the application performs a post-processing integrity check. This is performed in order to make sure that all files are processed and properly accounted for. Errors encountered in processing are displayed for the operator and the operator is able to a assign any errors encountered to various categories for subsequent corrective action.

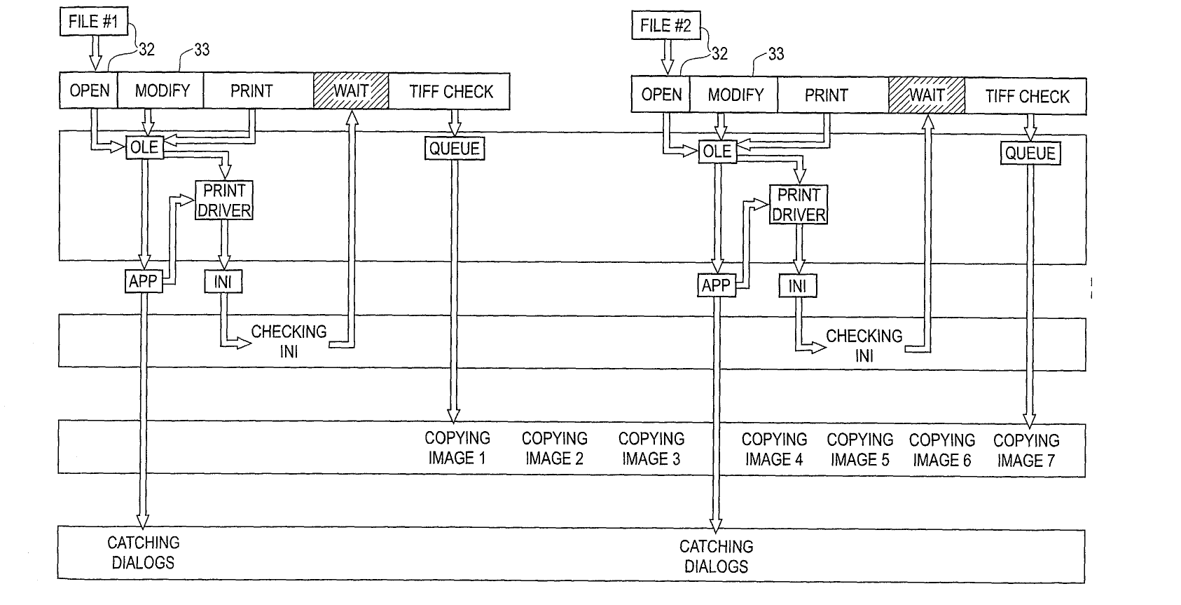

The preferred exemplary embodiment of the overall multithreaded structure and sequencing is shown in FIG. 3. As shown in FIG. 3, File No. 1 is opened in a first step 32 and modified at step 33. Similar operations occur in parallel on file No. 2 at a separate machine. These operations will now be described in greater detail.

For processing, initially an inventory is performed by scanning of the directory containing files to be converted and calculating the number and types of different files. This provides the user with complete statistics about the data to be translated into a common file format.

Once the system operator initiates operations, the application performs a pre-process integrity check on the data that is to be processed. This pre-process integrity check compares the number of files in different sub-directories of the target directory with the information in a catalog database. If integrity is verified as good (for example, all file counts match and all files listed in the database are physically present) the application proceeds to the next step.

If there are any discrepancies, complete information about the data is displayed so that the user can identify the errors and take the appropriate corrective action. The file conversion is then performed on each file for every file that is supported. In order to accomplish conversion, each file is opened, processed and submitted to the print driver for conversion. A final integrity check of the data is made and the user receives a complete error log.

In the preferred exemplary embodiment, initially settings are loaded from the system Registry of the machine on which the application is running all previous program settings. Alternatively, default settings are saved to the Registry if no settings are found in Registry. All path information is converted to UNC format eliminating the need for drive-letter mappings. The user then select a target directory for conversion. This directory can be dragged-and-dropped on to the programs application form and the application will populate itself with the required path information for its operations. This is accomplished through utilization of Windows Explorer. As noted above, the directory that is assigned to a particular machine in the network for processing is determined based on the number of machines that are available for processing as well as the number and amount of files that must be processed or converted. The assignment of tasks is made in order to balance the load on the available machines.

The system then scans the user directory and determines the number of files having different extensions. The system then creates a list and displays the results in the main application screen. If a user changes any setting option, the data is immediately changed in the Registry.

During analysis operations, the system calculates the number of files in each sub-folder of the selected target folder for conversion. The expected number of files is also determined from a catalog database in the preferred exemplary embodiment. The system also collects the number of existing records in the error log for this particular folder (if any) as well as the number of files in a further folder in which files that failed the automatic conversion process are placed. Various arithmetic verifications are made such as, for example, integrity checks where it is determined whether the number of files in all folders equal the number of records in a catalog database. The catalog database contains information on all files to be converted.

The system may also determine whether the number of files that failed the conversion process equals the number of records in the error log. When errors are located, the user is able to obtain a display of a detailed error report. If there is an error, the application provides the user with an interface to the catalog database with the ability to run custom queries against the database.

During TIFF conversion, each source file is copied from the storage server to a temporary directory on the local hard drive of the machine assigned to process this particular file. As noted above, the files that are to be converted are copied from the client media into the local server. Based on the file extension information for the particular file that is to be converted, an instance of an OLE automation object intended to manage this type of file is created. For every convertible file type, the system creates a software object that encapsulates the OLE automation procedure specific to processing that particular file type. OLE automation steps are then run for that particular file type.

An instance of the particular application used to process that file extension (Microsoft Word, Excel, WordPerfect etc.) are opened and all necessary properties of the application and document objects are set as follows:

set visible to false;

disable user input into application;

prevent application from asking questions and providing alerts;

cancel spelling and grammar checking;

enable virus protection.

Those skilled in the art will appreciate that these steps that have been described are exemplary only and a specific implementation of the invention may not necessarily perform all of the steps mentioned herein. These steps are simply what is considered the preferred exemplary embodiment.

In order to ensure that all relevant data is identified and provided in the translated version of the documents, certain additional steps are performed. As noted above, these steps similarly are not necessary or required in order to perform the conversion of the present invention.

The system goes through all sub-objects (for example, sheets in an Excel file) and the following steps may be performed. All necessary modifications are made in the file in order to eliminate local or otherwise updated information (for example, change headers, footers cannot etc. so that current machine, date and file name do not appear in the printed file). For Excel files, the system unhides hidden charts, columns and rows and Autofits the rows and columns. The content is unprotected and if this is unsuccessful the system does not try to modify anything. Automatic date, time and file name coding is removed.

For PowerPoint files, the system forces PowerPoint to show all objects. Automatic date, time and file name coding is removed. Print options are set and the system edits the .ini file for the tiff print driver to include current filename information. The system then executes the “print” operation on the Office application. This operation sends the file to the TIFF driver that writes out the pages of the document as individual TIFF files to the local drive. A separate thread continuously scans the .ini file of the print driver in order to determine that the file has finished processing and another file may be sent. The system then also goes through each of the pages of the file and saves the source text of each page as a separate file (“OCR.Page”). The step is performed in order to provide a separate text file for subsequent searching.

For each image from the print operation (and OCR page if applicable) the following additional operations are performed: set image attributes to 300×300 DP I, black and white, 2550×3300 pixels;

rotate the image to portrait if in landscape format; and

skip the page if there are no black pixels.

The system then adds the image file name to a queue for the copy thread of the application. This separate thread takes file names one at a time from its queue and copies the files to a destination folder. The system then closes the source file and copies the source file and its associated images as well as OCR files, if any, back to the storage server. If any errors are encountered during processing of the file, the full details of the error are written to an error log for that particular directory.

Final analyzing and error reporting is then performed. This portion of the operation is essentially an identical repeat of the steps performed during the initial analysis but with slightly different criteria for the comparison of the numbers for files. Essentially, comparisons are made to ensure that all of the files have been converted or are otherwise accounted for through error identification. When the program has completed processing of all files, the system displays an interface to the error log which gives the user the ability to assign error files to the different error categories. The user is also able to open any problem file for analysis. The user may also search the catalog database for particular file name or print an overall error report.

The systems and methods of the present invention have been described respect to preferred exemplary embodiments. Those skilled in the art will appreciate that all of the steps set forth above are not necessary to practicing the invention. Accordingly, the present invention should only be limited by the spirit and scope of the appended claims.

We claim:

1. A system for converting a plurality of data files into a common format comprising:
a plurality of data processing machines each of which has access to a respective plurality of data files;
the plurality of data processing machines connected to a common network with access to a common storage within which the plurality of data files are located; and
wherein each of the data processing machines are programmed to convert files from various formats into a common format.

2. The system of claim 1, wherein each of the plurality of data processing machines are personal computers.

3. The system of claim 1, wherein the common format is TIFF.

4. The system of claim 1 wherein each of the plurality of data processing machines is programmed to convert Microsoft Word documents into TIFF images.

5. The system of claim 1 wherein each of the plurality of data processing machines is programmed to convert WordPerfect documents into TIFF images.

6. A method for converting a plurality of data files into a common format comprising the steps of:
providing a plurality of data processing machines each of which has access to a respective plurality of data files wherein the plurality of data processing machines are connected to a common network with access to a common storage within which the plurality of data files are located; and
simultaneously using each of the data processing machines to convert files from various formats into a common format.

7. The method of claim 6, wherein each of the plurality of data processing machines are personal computers.

8. The method of claim 6, wherein the common format is TIFF.

9. The method of claim 6 wherein each of the plurality of data processing machines is programmed to convert Microsoft Word documents into TIFF images.

10. The method of claim 6 wherein each of the plurality of data processing machines is programmed to convert WordPerfect documents into TIFF images.
